(19) United States
(12) Patent Application Publication
(10) Pub. No.: US 2008/0306735 A1
(43) Pub. Date: Dec. 11, 2008

(54) SYSTEMS AND METHODS FOR INDICATING PRESENCE OF DATA

(76) Inventors: KENNETH RICHARD BRODHAGEN, Roswell, GA (US); Mark Alan Goodall, Chichester (GB); Damian Smith, Epsom (GB); Jamie Richard Williams, Fleet (GB)

Correspondence Address: NATHAN S. HUYNH, 5655 SILVER CREEK VALLEY ROAD #362, SAN JOSE, CA, 95138, US

(21) Appl. No.: 12/059,341

(22) Filed: Mar. 31, 2008

Related U.S. Application Data
(60) Provisional application No. 60/909,079, filed on Mar. 30, 2007.

(51) Int. Cl. G10L 11/02

(52) U.S. Cl. 704/231; 704/E11.003

(57) ABSTRACT

Included are systems and methods for indicating presence of data. At least one embodiment of a method includes receiving communications data associated with a communication session and determining at least one point of audio silence in the communications session. Some embodiments include creating tagging data configured to indicate the at least one point of audio silence in the communications session.

### RELATED APPLICATION

This application claims priority to U.S. provisional patent application number 60/909,079 filed on Mar. 30, 2007, which is incorporated by reference herein in its entirety.

### TECHNICAL FIELD

This disclosure relates to determining presence of data in a communication. More specifically, this disclosure relates to indicating the presence of data in a communication.

### BACKGROUND

In many communications environments, recording of data may be desired. However, as the number of communications in a communications environment increases, recording all transmitted data may be difficult. More specifically, problems with storage of large amounts of data with limited resources may inhibit recording capabilities. Additionally, bandwidth concerns may also serve to limit recording of data. As such, a need in the industry exists to facilitate efficient recording of data.

### SUMMARY

Included are systems and methods for indicating presence of data. At least one embodiment of a method includes receiving communications data associated with a communication session and determining at least one point of audio silence in the communications session. Some embodiments include creating tagging data configured to indicate the at least one point of audio silence in the communications session.

Also included are embodiments of a system for indicating presence of data. At least one embodiment of a system includes a receiving component configured to receive communications data associated with a communication session and a determining component configured to determine at least one point of audio silence in the communications session.

Also included are embodiments of a computer readable storage medium for indicating presence of data. At least one embodiment includes receiving logic configured to receive communications data associated with a communication session and determining logic configured to determine at least one point of audio silence in the communications session.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

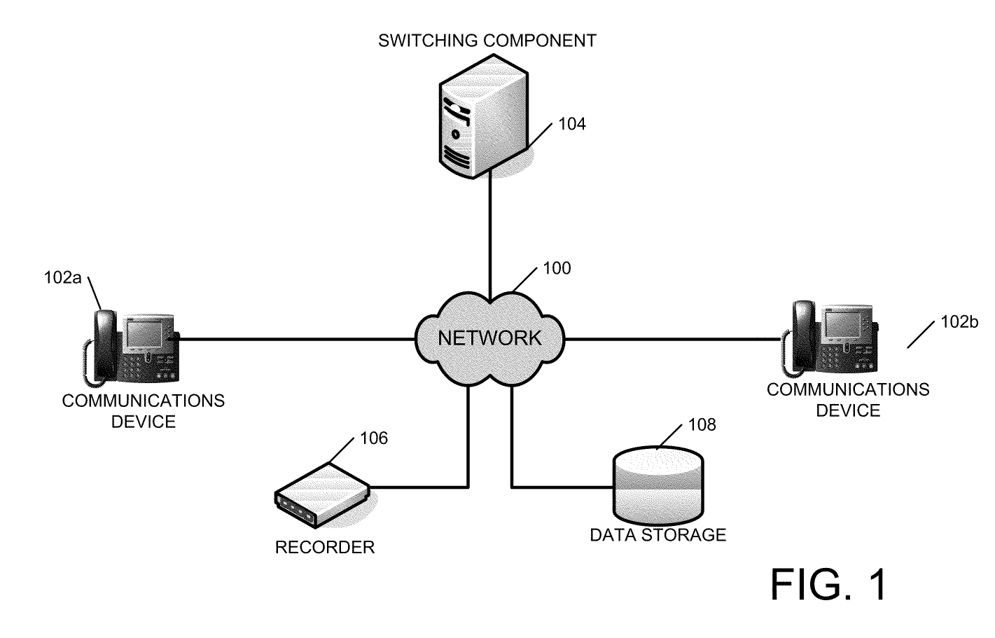

FIG. 1 is an exemplary embodiment of a communications environment, which may be configured for recording communication data.

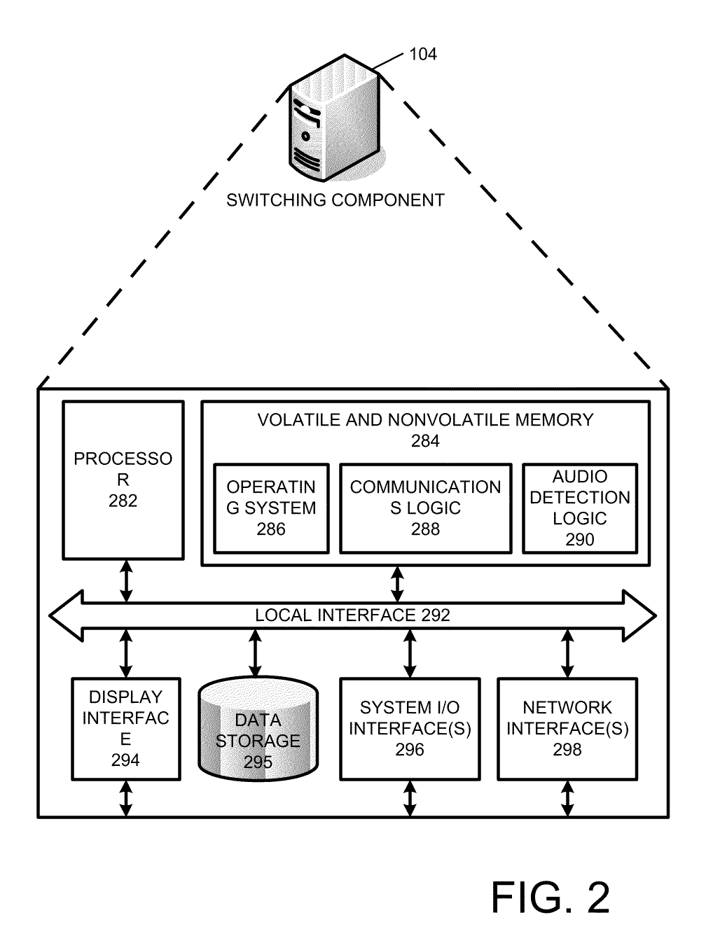

FIG. 2 is an exemplary embodiment of a switching component that may be configured for facilitating communications between a plurality of communications devices, similar to the switching component from FIG. 1.

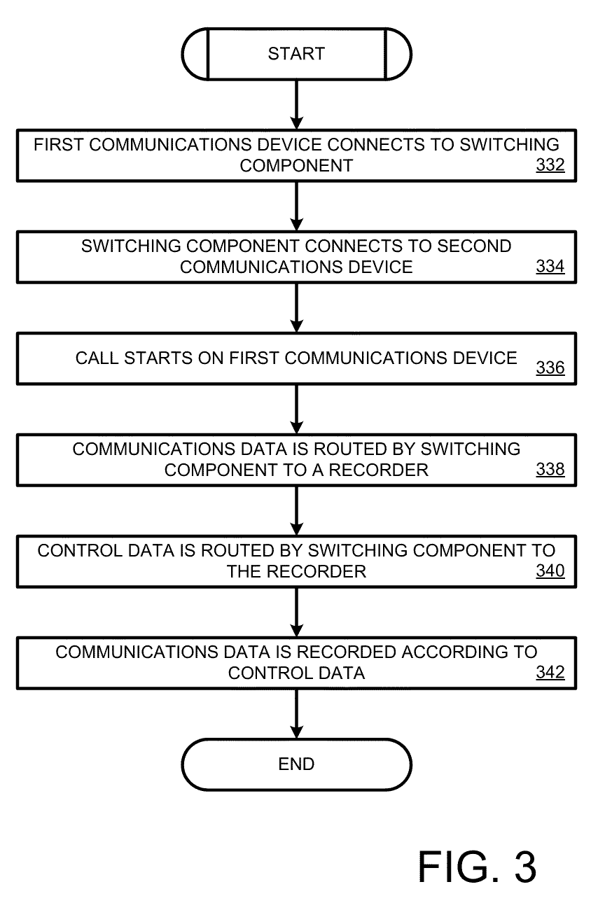

FIG. 3 is an exemplary embodiment of a process that may be utilized for recording data in a communications environment, such as the environment from FIG. 1.

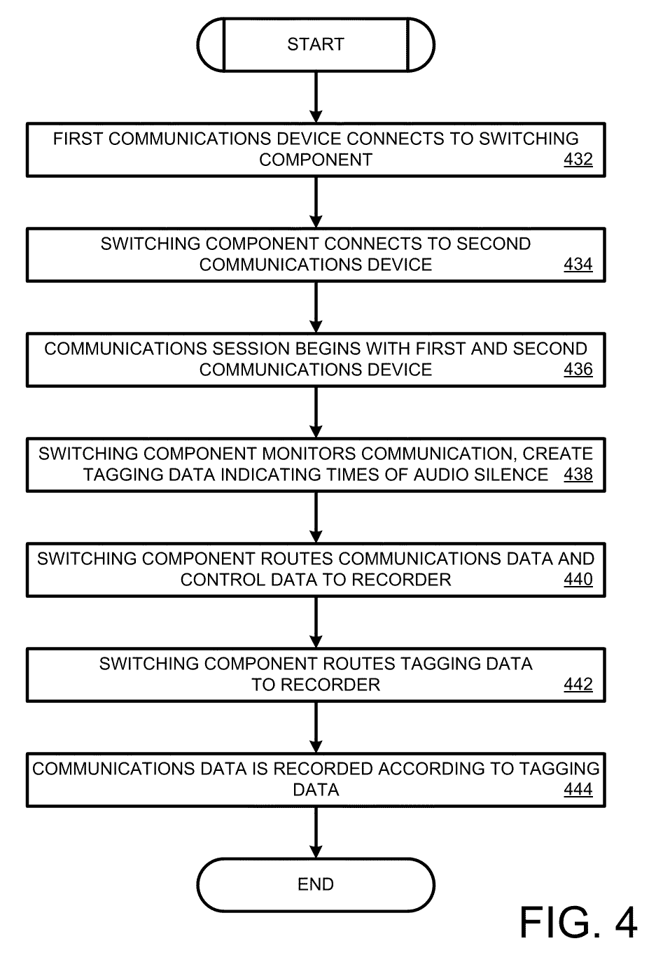

FIG. 4 is an exemplary embodiment of a process that may be utilized for recording tagged data from a data stream that is distinct from communications data, similar to the process from FIG. 3.

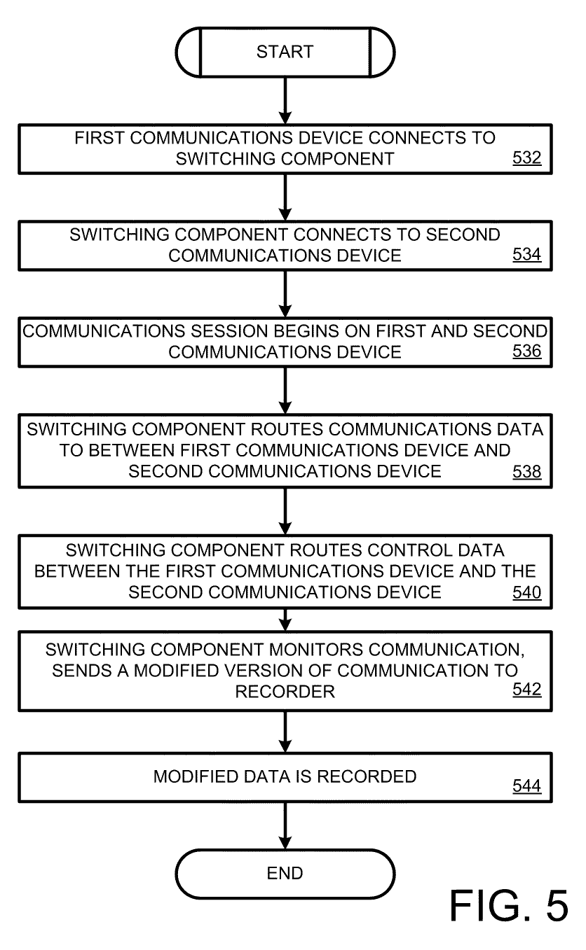

FIG. 5 is an exemplary embodiment of a process that may be utilized for recording modified data, similar to the process from FIG. 4.

### DETAILED DESCRIPTION

Included are embodiments for tagging communications data in a communications environment. More specifically, embodiments included herein, among others, may be configured to determine times of audio silence in a communication. Similarly, embodiments, among others, may be configured to tag the portions of the audio silence and send the tagged data to the recorder. The recorder may be configured to determine the portions of audio silence from the tagged data and record the communications data accordingly. Other embodiments are also included.

FIG. 1 is an exemplary embodiment of a communications environment, which may be configured for recording communication data. As illustrated in the nonlimiting example of FIG. 1, a first communications device 102a may be coupled to a network 100. The first communications device 102a may be configured to send data to and receive data from a second communications device 102b, via a switching component 104. More specifically, the switching component 104 may be configured to receive communications data and/or control data from a communications device 102a, 102b (collectively referred to as 102) and determine a path for sending the data to the desired recipient.

Additionally coupled to the network 100 is a recorder 106. The recorder 106 may be configured to receive communications data and/or control data from the switching component 104 and/or from one or more of the communications devices 102. More specifically, in an exemplary embodiment the communications device 102a may be engaged in a communication with communications device 102b. The switching component 104 may be configured to determine a desired path for sending data to the communications path. Once the switching component 104 has established a link between the communications devices 102, the switching component 104 may send data sent between the communications devices to the recorder 106. The recorder 106 may be configured to record and the store the received data locally and/or send at least a portion of the received data to a data storage component 108.

Similarly, in some embodiments, one or more of the communications devices 102 may be configured to send data to the recorder 106, without utilization of the switching component 104. More specifically, in at least one exemplary embodiment, the communications device 102a may be configured to send all data related to a communication to the recorder 106 via the without utilization of the switching component 104. In some embodiments, the communications device 102a may be configured to send at least a portion of the data associated with the communication to the recorder 106 and the communications device 102b may be configured to send at least a portion of the data to the recorder 106. In such a configuration each communications device 102 may be configured to send outgoing data (or incoming) from that device. Additionally, some configurations can be configured such that both communications devices 102 send incoming and outgoing data, such that the recorder can receive redundant data, thereby ensuring accuracy of the data.

One should note that while the exemplary embodiment of FIG. 1 illustrates a configuration with two communications devices 102, one switching component 104, one recorder 106, and one data storage component 108, this is a nonlimiting example. More specifically, as communications may be facilitated among any number of communications devices 102, one or more communications devices 102 may be utilized. Additionally, as a single switching component 104 is illustrated in FIG. 1, this is also a nonlimiting example. Depending on the particular configuration, one or more Service Switching Points (SSPs), Signal Transfer Points (STPs), call control servers, etc. may be utilized. Additionally, while the switching component 104 is illustrated as a server, this is also a nonlimiting example, as the switching component 104 may be utilized as any number of components, depending on the particular embodiment.

FIG. 2 is an exemplary embodiment of a switching component that may be configured for facilitating communications between a plurality of communications devices, similar to the switching component from FIG. 1. Although a wire-line switching component 104 is illustrated, this discussion can be applied to wireless devices, as well. Generally, in terms of hardware architecture, as shown in FIG. 2, the switching component 104 may include a processor 282, a memory component 284 (which may include volatile and/or nonvolatile memory components), a display interface 294, a data storage component 295, one or more input and/or output (I/O) device interface(s) 296, and/or one or more network interfaces 298 that are communicatively coupled via a local interface 292. The local interface 292 can include, for example but not limited to, one or more buses or other wired or wireless connections. The local interface 292 may have additional elements, which are omitted for simplicity, such as controllers, buffers (caches), drivers, repeaters, and receivers to enable communications. Further, the local interface 292 may include address, control, and/or data connections to enable appropriate communications among the aforementioned components. The processor 282 may be a device for executing software, particularly software stored in the memory component 284.

The processor 282 can be any custom made or commercially available processor, a central processing unit (CPU), an auxiliary processor among several processors, a semiconductor based microprocessor (in the form of a microchip or chip set), a macroprocessor, or generally any device for executing software instructions.

The memory component 284 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory component 284 may incorporate electronic, magnetic, optical, and/or other types of storage media. One should note that some embodiments of the memory component 284 can have a distributed architecture (where various components are situated remotely from one another), but can be accessed by the processor 282.

The software in the memory component 284 may include one or more separate programs, each of which includes an ordered listing of executable instructions for implementing logical functions. In the example of FIG. 2, the software in the memory component 284 may include an operating system 286, communications logic 288, and audio detection logic 290. The operating system 286 may be configured to control the execution of other computer programs and provides scheduling, input-output control, file and data management, memory management, and communication control and related services.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 284, so as to operate properly in connection with the operating system 286.

The Input/Output devices that may be coupled to system I/O Interface(s) 296 may include input devices, for example but not limited to, a keyboard, mouse, scanner, microphone, etc. Further, the Input/Output devices may also include output devices, for example but not limited to, a printer, display, speaker, etc. Additionally, the Input/Output devices may further include devices that communicate both as inputs and outputs, for instance but not limited to, a modulator/demodulator (modem; for accessing another device, system, or network), a radio frequency (RF) or other transceiver, a telephonic interface, a media duplication system, a router, etc.

Additionally included are one or more network interfaces 298 for facilitating communication with one or more other devices. More specifically, a network interface 298 may include any component configured to facilitate a connection with another device. While in some embodiments, among others, the switching component 104 can include a network interface 298 that includes a Personal Computer Memory Card International Association (PCMCIA) card (also abbreviated as “PC card”) for receiving a wireless network card, however this is a nonlimiting example. Other configurations can include the communications hardware within the computing device, such that a wireless network card is unnecessary for communicating wirelessly. Similarly, other embodiments include network interfaces 298 for communicating via a wired connection. Such interfaces may be configured with Universal Serial Bus (USB) interfaces, serial ports, and/or other interfaces.

If the switching component 104 includes a personal computer, workstation, or the like, the software in the memory component 284 may further include a basic input output system (BIOS) (omitted for simplicity).

The BIOS is a set of software routines that initialize and test hardware at startup, start the operating system 286, and support the transfer of data among the hardware devices. The BIOS is stored in ROM so that the BIOS can be executed when the switching component 104 is activated.

When switching component 104 is in operation, the processor 282 may be configured to execute software stored within the memory component 284, to communicate data to and from the memory component 284, and to generally control operations of the switching component 104 pursuant to the software. Software in memory, in whole or in part, may be read by the processor 282, perhaps buffered within the processor 282, and then executed.

One should note that while the description with respect to FIG. 2 includes a switching component 104 as a single component, this is a nonlimiting example. More specifically, in at least one embodiment, the switching component 104 can include a plurality of servers, personal computers, and/or other devices. Similarly, while the communications logic 288 and audio detection logic 290 are each illustrated in FIG. 2 as single software components, this is also a nonlimiting example. In at least one embodiment, this logic may include one or more components, embodied in software, hardware, and/or firmware. Additionally, while the communications logic 288 and audio detection logic 290 are depicted as residing on a single computing device, this logic may reside on one or more devices.

Similarly, while the discussion with regard to FIG. 2 refers to a switching component 104, the above description may be applied to other components. More specifically, the recorder 106, one or more of the communications devices 102, the data storage component 108, a load balancer (not shown), a replay component (not shown), a recorder controller (not shown), a call control server (not shown), and/or other components may include similar elements and/or operate similarly.

FIG. 3 is an exemplary embodiment of a process that may be utilized for recording data in a communications environment, such as the environment from FIG. 1. As illustrated in the nonlimiting example of FIG. 3, the first communications device 102a may connect to the switching component 104 (block 332). The switching component 104 can then connect to the second communications device (block 334). A communications session can then begin on the first and second communications devices (block 336). During the communications session, communications data can be routed by the switching component 104 to the recorder 106 (block 338). More specifically, in at least one exemplary embodiment, the switching component 104 may be configured to receive communications data and control data from the communications devices 102. The communications data received at the switching component 104 may be then sent to a destination based on the control data. Additionally, the switching component 104 can send a copy of the communications data to the recorder 106. Additionally, the switching component 104 may be configured to analyze the received communication data to determine one or more time periods of silence within the communication. The switching component 104 may then send tagging information that indicates the periods of silence as part of the control data (block 340). The recorder 106 can then receive the communications data and the control data and record the communications data according to the control data (block 342).

More specifically, in at least one nonlimiting example, the recorder 106 may be configured with logic to determine whether tagging information is present with the control data, as well as logic configured to determine the times of audio silence, as indicated by the tagging data. Upon determining the times of audio silence, the recorder may be configured to record only those portions of the received communications data without audio silence.

FIG. 4 is an exemplary embodiment of a process that may be utilized for recording tagged data from a data stream that is distinct from communications data, similar to the process from FIG. 3. As illustrated in the nonlimiting example of FIG. 4, the first communications device 102a can connect to the switching component 104 to initiate a communications session with the second communications device 102b (block 432). The switching component 104 can then determine the address of the second communications device 102b and connect with the second communications device 102b (block 434). The communications session can then begin with the first communications device 102a and second communications device 102b (block 436). The switching component 104 can monitor the communications session to determine times of audio silence. The switching component 104 can then create tagging data related to the times of audio silence (block 438). The communications data and control data can be routed by the switching component 104 to the recorder 106 (block 440). The switching component 104 can route the tagging data to the recorder 106 (block 442). The recorder can then record data according to the tagging data (block 444).

FIG. 5 is an exemplary embodiment of a process that may be utilized for recording modified data, similar to the process from FIG. 4. As illustrated in the nonlimiting example of FIG. 5, the first communications device 102a may be configured to connect with the switching component 104 (block 532). The switching component 104 can connect to the second communications device 102b (block 534). As discussed above, the first communications device 102a and the second communications device 102b may be configured to connect to the switching component 104 for facilitating a communications session. The communications session can then begin between the first communications device 102a and the second communications device 102b (block 536).

The switching component 104 can route communications data between the first communications device 102a and the second communications device 102b (block 538). The switching component can route control data between the first communications device 102a and the second communications device 102b (block 540). The switching component 104 can monitor the communication data and determine at least one time of audio silence. The switching component 104 can then remove the portions of the communications data that contain audio silence, and send the modified version of the communications data to the recorder 106 (block 542). The recorder 106 can record the modified communications data (block 544).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software- configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for indicating presence of data, comprising:
receiving communications data associated with a communication session;
determining at least one point of audio silence in the communications session; and
creating tagging data configured to indicate the at least one point of audio silence in the communications session.

2. The method of claim 1, further comprising sending the tagging data to a recorder.

3. The method of claim 2, further comprising sending control data to the recorder, wherein the tagging data is sent to the recorder with the control data.

4. The method of claim 2, further comprising sending control data to a recorder, wherein the tagging data is sent to the recorder separately from the control data.

5. The method of claim 1, further comprising sending the communications data a recorder.

6. The method of claim 1, further comprising modifying the communications data according to the tagging data.

7. The method of claim 6, further comprising sending the modified communications data to a recorder.

8. A system for indicating presence of data, comprising:
a receiving component configured to receive communications data associated with a communication session;
a determining component configured to determine at least one point of audio silence in the communications session;
a creating component configured to create tagging data configured to indicate the at least one point of audio silence in the communications session; and
a first sending component configured to send the tagging data to a recorder.

9. The system of claim 8, further comprising a second sending component configured to send control data to the recorder, wherein the tagging data is sent to the recorder with the control data.

10. The system of claim 8, further comprising a third sending component configured to send control data to the recorder, wherein the tagging data is sent to the recorder separately from the control data.

11. The system of claim 8, further comprising a fourth sending component configured to send the communications data a recorder.

12. The system of claim 8, further comprising a modifying component configured to modify the communications data according to the tagging data.

13. The system medium of claim 12, further comprising means for sending the modified communications data to a recorder.

14. A computer readable storage medium for indicating presence of data, comprising:
receiving logic configured to receive communications data associated with a communication session;
determining logic configured to determine at least one point of audio silence in the communications session; and
creating logic configured to create tagging data configured to indicate the at least one point of audio silence in the communications session,
wherein tagging data is formatted for a recorder to determine the at least one point of audio silence.

15. The computer readable storage medium of claim 14, further comprising first sending logic configured to send the tagging data to the recorder.

16. The computer readable storage medium of claim 15, further comprising second sending logic configured to send control data to the recorder, wherein the tagging data is sent to the recorder with the control data.

17. The computer readable storage medium of claim 15, further comprising third sending logic configured to send control data to the recorder, wherein the tagging data is sent to the recorder separately from the control data.

18. The computer readable storage medium of claim 14, further comprising fourth sending logic configured to send the communications data the recorder.

19. The computer readable storage medium of claim 14, further comprising modifying logic configured to modify the communications data according to the tagging data.

20. The computer readable storage medium of claim 19, further comprising sending logic configured to send the modified communications data to a recorder.
